(19) United States
(12) Patent Application Publication
(10) Pub. No.: US 2008/0308429 A1
(43) Pub. Date: Dec. 18, 2008

(54) METHOD FOR IMPROVING CATHODE MORPHOLOGY

(75) Inventor: BRUCE JOHN LOVE, Georgetown (CA)

Correspondence Address: INCO PATENTS & LICENSING, PARK 80 WEST - PLAZA TWO, SADDLE BROOK, NJ, 07663, US

(73) Assignee: CVRD INCO LIMITED, TORONTO (CA)

(21) Appl. No.: 11/764,263

(22) Filed: Jun. 18, 2007

(51) Int. Cl. C25C 1/08; C25C 7/02; H01M 6/04

(52) U.S. Cl. 205/595; 204/242; 429/347

(57) ABSTRACT

An acidic aqueous electrolyte solution for production of a nickel cathode is provided which includes nickel ions, and 2,5-dimethyl-3-hexyne-2,5-diol. The 2,5-dimethyl-3-hexyne-2,5-diol may be present in the acidic aqueous electrolyte solution in an amount ranging from about 5 ppm to about 300 ppm. Also provided is a process for electrowinning or electrorefining a nickel cathode which includes providing an acidic aqueous electrolyte solution including nickel ions, and 2,5-dimethyl-3-hexyne-2,5-diol; and electrolytically depositing nickel to form a nickel cathode. Addition of 2,5-dimethyl-3-hexyne-2,5-diol results in a reduction of striations and other defects which may occur on the surface of cathodes made by electrowinning or electrorefining.

### TECHNICAL FIELD

The present disclosure relates to electrowinning and/or electrorefining of nickel cathode from aqueous nickel electrolytes.

### DESCRIPTION OF RELATED ART

Nickel sulfate catholytes containing chloride anions up to approximately 30 g/l produce large grain structures when deposited for considerable time, as is the standard practice for commercial electrorefining and/or electrowinning of nickel cathode. The naturally occurring grain structure interacts with the natural upward flow of electrolyte past the cathode surface. These phenomena result in the formation of a vertical striated pattern of metal growth. Similar phenomena can be observed during the electrorefining of other metals such as cobalt and copper. The pattern of vertical striation becomes an increasingly dominant feature of the cathode surface with increasing deposition time. Rough cathode surface features can lead to dendritic growth. These phenomena can effectively limit the practical thickness of cathodes that are attainable from commercial nickel electrorefining processes. A cathode with a rough surface can encapsulate small quantities of the electrolyte from which it is being deposited resulting in an elevated sulfur analysis due to the entrainment of sulfate anions. Rough surfaced cathodes are considered undesirable from a processing, handling and aesthetic perspective.

In order to retard the striation phenomena and/or reduce the propensity for the formation of dendritic type growth at a given current density, a reduction of the deposited nickel grain size and/or a change in the crystal orientation is required. The following techniques have been utilized to reduce gain size: 1) Gas sparging into the bottom of a cell can be used to produce a smooth cathode surface as described, e.g., in U.S. Pat. No. 3,959,111. However, this process results in increased capital and operational costs to install and operate the air sparging equipment. In addition, considerable generation of electrolyte mist results in tank house environmental issues. 2) The catholyte can be maintained at a lower pH range, for example, pH 2.0-3.0. This increases the propensity for hydrogen gas evolution at the cathode and results in intimate mixing of the catholyte at the cathode surface, thus allowing for a smoother thicker cathode to be deposited. This result is achieved at the expense of tank house environmental issues and the added cost of depositing nickel at significantly lower current efficiencies. 3) Pulsed plating is known to be an effective technique for reducing the grain size and may prove useful to prevent the observed striation effect, which limits the surface smoothness and thus the practical thickness achievable. See, for example, U.S. Pat. No. 5,352,266. This methodology is not considered economically viable for commercial scale primary production of cathode nickel. The D.C. pulse rectifiers are very expensive and not readily available in the sizes required for commercial nickel cathode production. Pulse plating efficiencies are low and the process uses substantial quantities of organic additives that may not be compatible with the commercial refining processes.

Numerous techniques exist for electroplating nickel. Many existing techniques are concerned with producing plated deposits, which are at less than 0.05 cm thick. Many techniques are designed for plating one or more layers of multi-layered products. Many electrolyte compositions utilized in such techniques contain multiple additives at elevated concentrations that are inappropriate for use in a flow-through electrowinning process and/or a closed loop continuous process. Many of the formulations use chemicals that contain sulfur. These sulfur-containing chemicals are incorporated into the deposited cathode, making it unacceptable for many end usages. Quality commercial nickel electrowinning and/or electrorefining cathode may generally have a sulfur content specification of <10.0 ppm. Certain nickel plating techniques utilize sodium free Watts type nickel electrolytes and high boric acid concentrations. Commercial nickel electrowinning and/or electrorefining electrolytes generally contain sodium at elevated concentrations that can be incompatible with some standard additive formulations. Commercial nickel and/or electrorefining electrolytes generally contain much lower concentrations of boric acid than do those used for plating techniques.

U.S. Pat. No. 3,898,138 is directed to a method and bath for the electrodeposition of nickel. As described therein, a specific combination of compounds results in nickel deposits which are fine grained, lustrous, and ductile and which have improved leveling characteristics. In particular, three conjunctive ingredients, i.e., an aryl sulfon, an acetylenic alcohol and an olefinic alcohol are utilized. The specification refers, at column 3, to a synergistic effect which can be obtained from the incorporation of a specific mixture of specific unsaturated alcohols into the aqueous acidic nickel plating baths, i.e., the conjunctive use of a combination of three specific compounds, namely metasulfobenzoic acid and a mixture of an acetylenic alcohol and an alkene alcohol containing four carbon atoms. Two preferred alkyne diols are exemplified, namely, butyne 1,4 diol, HOCH₂CC: CCH₂OH or 3-hexyne 2,5 diol, CH₃CH(OH)C: C—CH(OH)CH₃. This ingredient is added in an amount ranging from about 0.05 to about 0.5 grams per liter of the solution.

U.S. Pat. No. 4,288,305 is directed to a process for electrowinning nickel or cobalt from an electrolyte in apparatus having spaced insoluble anodes and cathodes. Each anode is provided with diaphragm means for defining an anolyte compartment. A frothing agent is introduced into the feed electrolyte which expedites the withdrawal of spent electrolyte and anodically generated gases. The presence of a stable froth above the anolyte is essential to the success of the process in ensuring simultaneous withdrawal of gases and spent electrolyte. The requisite froth can be maintained by including in the feed electrolyte any convenient frothing agent which does not introduce unacceptable ionic species into the system. Many surface active agents commercially sold as flotation reagents may be used for this purpose. An example of a frothing agent is sodium lauryl sulfate, at a concentration of 10-50 mg/l, e.g., 30 milligrams thereof per liter of electrolyte.

U.S. Pat. No. 5,164,068 is directed to a nickel electroplating solution and acetylenic compounds therefore. As described therein, an aqueous acid electroplating solution comprising nickel ions and one or more acetylenic compounds, specifically mono- and polyglyceryl ethers of acetylenic alcohols permits successful nickel plating of irregular surfaces such as printed circuit boards having through-holes of high aspect ratios.

U.S. Pat. No. 5,352,266 is directed to nanocrystalline metals having an average grain size of less than about 11 nanometers and process for producing the same. The nanocrystalline material is electrodeposited onto the cathode in an aqueous acidic electrolytic cell by application of a pulsed D.C. current. The cell electrolyte also contains a stress reliever, such as saccharin, which helps to control the grain size. Saccharin is a known stress reliever and grain refining agent and may be added in amounts up to about 10 gm/l. Other stress relievers and grain refining agents which may be added include coumarin and thiourea. If the bath temperature rises, it may be desirable to add a grain size inhibitor such as phosphorous acid in relatively small amounts up to about 0.5-1 gm/l. The quantities of additives added in this case are far greater than would be practical in the case of electrowinning and/or electrorefining. Coumarin has a strong odor and is known to break down to melilotic acid at the cathode. Both saccharin and thiourea will lead to sulfur incorporation.

The ability to deposit thick coherent, smooth nickel and to do so at increased current densities provides economic advantages. Thick smooth nickel can attract market premiums since it is a desired form of metal, while controlled production at higher current densities results in greater economic production efficiency. U.S. Pat. No. 6,428,604 is directed to a hydrometallurgical process for the recovery of nickel and cobalt values from a sulfidic flotation concentrate. The process involves forming a slurry of the sulfidic flotation concentrate in an acid solution, and subjecting the slurried flotation concentrate to a chlorine leach at atmospheric pressure followed by an oxidative pressure leach. After liquid-solids separation and purification of the concentrate resulting in the removal of copper and cobalt, the nickel-containing solution is directly treated by electrowinning to recover nickel cathode therefrom. A previous practical limit for nickel being electrowon from a process such as that described in U.S. Pat. No. 6,428,604 was approximately 6 to 8 days of deposition at approximately 220 Amps/m² using standard bagged anode nickel refining cell configurations and flows.

Existing commercial nickel plating additive formulations generally contain multiple chemical additives. Such formulations are not optimized for use in commercial electrowinning or electrorefining operations. Excess additives tend to result in brittleness and high stress in thick deposits which can readily then exfoliate from the cathode mandrel while deposition is continuing. Thus, there is a need for techniques that allow thick, smooth nickel cathodes to be efficiently produced under electrowinning conditions required for commercial nickel refining.

### SUMMARY OF THE INVENTION

An acidic aqueous electrolyte solution for production of a nickel cathode is provided which includes nickel ions, and 2,5-dimethyl-3-hexyne-2,5-diol. The 2,5-dimethyl-3-hexyne-2,5-diol may be present in the acidic aqueous electrolyte solution in an amount ranging from about 5 ppm to about 300 ppm. Also provided is a process for electrowinning or electrorefining a nickel cathode which includes providing an acidic aqueous electrolyte solution including nickel ions, and 2,5-dimethyl-3-hexyne-2,5-diol; and electrolytically depositing nickel to form a nickel cathode.

### BRIEF DESCRIPTION OF THE DRAWINGS

FIG. 1a is an image of striated nickel from a cathode produced in accordance with the prior art.

FIG. 1b is an image of three pieces of nickel sheared from a full size cathode such as that shown in FIG. 1a.

FIG. 2 is an image of a nickel cathode produced using 150 ppm 2,5-dimethyl-3-hexyne-2,5-diol.

FIG. 3 is an image of a nickel cathode produced using 100 ppm 2,5-dimethyl-3-hexyne-2,5-diol.

FIG. 4 is an image of eight discrete ring-shaped nickel cathodes with fluted sides produced using 100 ppm 2,5-dimethyl-3-hexyne-2,5-diol.

### DESCRIPTION OF PREFERRED EMBODIMENTS

Nickel cathodes are efficiently produced in accordance with the techniques and compositions disclosed herein that are thick, uniform and have uncommonly smooth surface topography. The present techniques allow electrolytic deposition of thick, coherent, and well-leveled nickel cathodes at high current densities in electrorefining or electrowinning catholyte compositions that are known to produce striated commercial cathodes of limited thickness. It has surprisingly been determined that addition of a 2,5-dimethyl-3-hexyne-2,5-diol (“DMHD”) to suitable electrolyte solutions for nickel electrowinning or electrorefining results in a reduction of striations and other surface defects in nickel cathodes. Without wishing to be bound by any particular theory, it is believed that such reduction is due to reduction of grain size and/or orientation of the deposited metal. This reduces the propensity for domanite grains to protrude beyond the deposited surface plane and induce changes in the mixing patterns of the catholyte that naturally moves up the electrode surface, eventually leading to the development of striations during the long deposition times applicable to an electrowinning or electrorefining process. The process of the present invention is equally applicable to electrowinning or electrorefining of nickel from sulfate, chloride or mixed chloride and sulfate catholytes.

It is contemplated that any method known to those skilled in the art may be utilized to obtain nickel containing electrolytes prepared, for example, by the extraction or leaching of nickel from concentrates, nickel mattes and/or other intermediate nickel refinery feeds. For example, suitable nickel catholyte compositions may have the following general composition: about 48 to about 100 g/l Ni, about 0 to about 30 g/l Cl, about 1 to about 30 g/l Na, about 0 to about 20 g/l boric acid. Other suitable nickel catholyte compositions involve a nickel sulfate electrolyte. These all-sulfate based nickel compositions may generally have nickel catholytes with the following composition ranges: about 50 to about 80 g/l Ni, about 10 to about 50 g/l Na and may contain boric acid in the range of about 0 to about 20 g/l.

In one embodiment, a purified high strength nickel sulfate-chloride solution for use in electrowinning or electrorefining can be obtained in accordance with U.S. Pat. No. 6,428,604. This solution may typically contain about 80 g/l Ni and has a pH value of about 4.0. The purified nickel sulfate-chloride solution is electrolyzed to deposit metallic nickel on the cathodes and to produce chlorine, oxygen and sulfuric acid at the anodes.

2,5-dimethyl-3-hexyne-2,5-diol may be added to the nickel catholyte in amounts ranging from about 5 ppm to about 300 ppm. Examples of nickel containing catholytes include, but are not limited to, 1) about 55 to about 100 g/l nickel, about 0 to about 30 g/l chloride, about 1-30 g/l sodium, about 0 to about 20 g/l boric acid and about 5 ppm to about 300 ppm 2,5-dimethyl-3-hexyne-2,5-diol, 2) about 55 to about 100 g/l nickel, about 3 to about 8 g/l chloride, about 8 to about 12 g/l sodium, about 4 to about 8 g/l boric acid and about 80 to about 175 ppm 2,5-dimethyl-3-hexyne-2,5-diol, and 3) about 90 g/l nickel, about 6 g/l chloride, about 10 g/l sodium, about 6 g/l boric acid and about 100 to about 150 ppm 2,5-dimethyl-3-hexyne-2,5-diol.

It is contemplated that the electrolyte solutions utilized herein may contain other additives generally known to those skilled in the art. For example, surfactants, brighteners and emulsifiers are typical additives.

The purified high strength nickel sulfate-chloride solution may be fed to conventional electrowinning or electrorefining cells containing a plurality of insoluble anodes interspersed with a plurality of cathodes which may be either nickel starter sheets or permanent cathode substrates fabricated from titanium or stainless steel. In operation, 2,5-dimethyl-3-hexyne-2,5-diol may be supplied in a feed solution during the electrowinning or electrorefining process. In one embodiment, the nickel cathode is deposited using a dissolving matte anode. Nickel can be produced as full-plate cathode by plating on to nickel starter sheets, or as discrete pieces, such as ROUNDS™, by plating on to partially masked conductive substrates (ROUNDS is a trademark of CVRD Inco Limited). The insoluble anodes can consist of metallic titanium substrates, either mesh, rods or full plate, coated with one or more overlayers of a transition metal oxide, preferably selected from tantalum, ruthenium, tin and iridium oxides. Each anode may be enclosed in a sheath or bag made from a semi-permeable membrane, with a hood means for removal of oxygen and chlorine gas and anolyte solution, as described, e.g., in U.S. Pat. No. 4,201,653 and U.S. Pat. No. 4,288,305.

The nickel electrowinning or electrorefining process may be operated at a current density of about 200 to about 800 amp/m² at about 30° C. to about 90° C., and more preferably between about 50° C. to about 65° C., e.g., about 60° C. The pH of the acidic aqueous electrolyte solution may range from about 3.5 to about 4.5. It is to be noted that the chloride concentration of the nickel electrowinning circuit feed solution in U.S. Pat. No. 6,428,604 can remain inherently in the range of between about 2 to about 20 g/L. The purified nickel sulfate-chloride solution, typically containing about 70 to about 100 g/L Ni, is added to the circulating catholyte, which is pH adjusted and filtered prior to entering the cell where metallic nickel is plated on to the cathode. The catholyte solution permeates through the membrane enclosing the anode compartment, to the surface of the anode where chlorine and oxygen are formed. The nickel anolyte stream, recovered from the anode compartment along with chlorine and oxygen gases, generally contains about 50 g/L Ni, less than about 1-10 g/L Cl, and about 20 to about 60 g/L H₂SO₄.

Cathode thickness is a function of the applied current density and the number of hours of cathodic deposition. Nickel plating applications where the plating time is quite short, generally only several minutes, produces thin protective and/or cosmetic nickel coatings. In commercial nickel refining processes, the nickel cathode produced is deposited for many days. Generally deposition times of greater than 6 days may be used resulting in cathode of varying thickness from about 6 to about 18 mm depending on the type of electrolyte used, the current density and the duration.

The process and compositions of the invention will now be described having reference to the following examples which are included to illustrate certain aspects of the invention, but are not intended to limit the invention.

### COMPARATIVE EXAMPLE 1

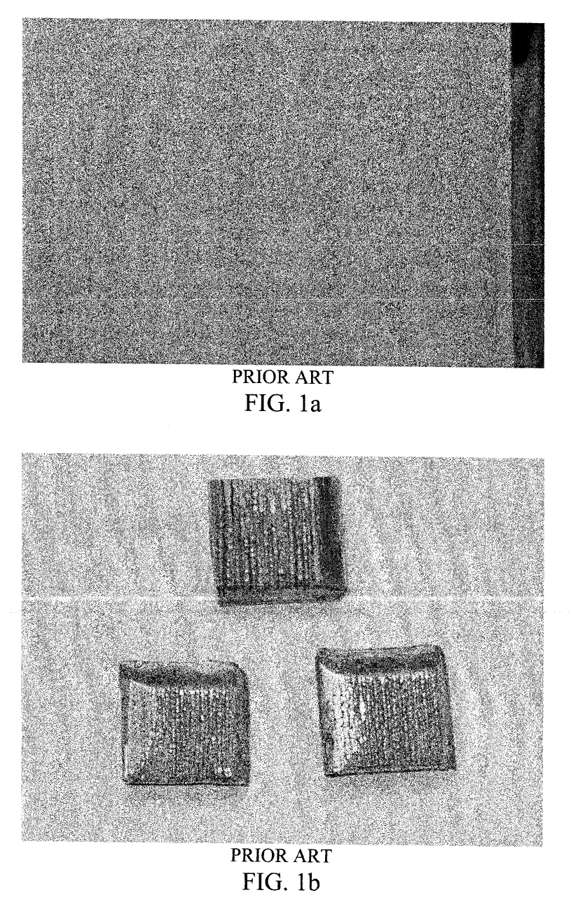

Nickel cathode was electrowon using a dimensionally stable inert anode contained in an anode box which supported a diaphragm cloth such that the anode compartment was separated from the cell catholyte. The nickel was electrowon from a mixed sulfate/chloride electrolyte containing 55 g/l Ni, 3-5 g/l Cl, 10 g/l Na and 6 g/l boric acid. The fresh feed solution contained 90 g/l Ni, 6 g/l Cl, 10 g/l Na and 6 g/l boric acid. The circulating catholyte was controlled to pH 3.5 by the addition of 12.5% Na₂CO₃ solution to the pH adjustment tank. The catholyte was circulated between the cell and the pH adjustment tank at a ratio of 20 times the fresh feed rate. Anolyte and anode gases (chlorine and oxygen) were withdrawn from the anode boxes under vacuum. The temperature of the cell and the circulating electrolyte was maintained at 60° C. The applied current density was held constant at 220 amps/m². The deposition continued for a period of 8 days. The nickel cathode was on average 12.05±0.91 mm thick. The resulting cathode had a striated surface appearance as shown in FIGS. 1a and 1b. FIG. 1a is an image of full scale striated nickel cathode produced as described in Comparative Example 1. FIG. 1b is an image of three 1×1 inches (25.4×25.4 mm) pieces of nickel sheared from a full size cathode such as that shown in FIG. 1a, and produced as described in Comparative Example 1. The surface striations are readily apparent.

### EXAMPLE I

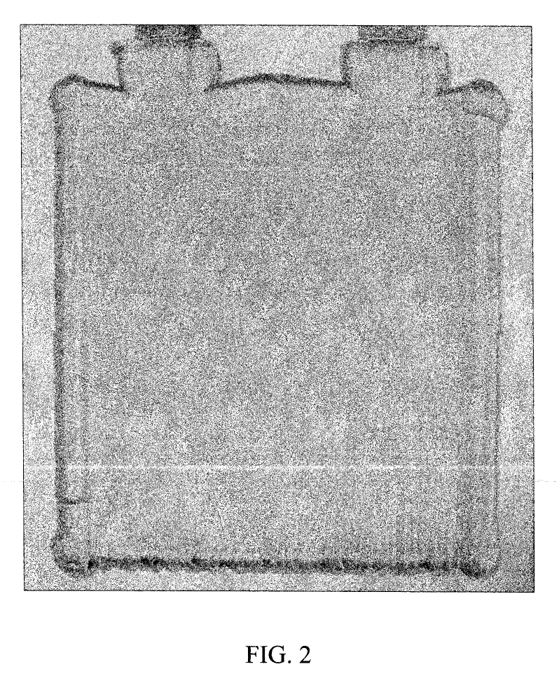

A electrolytic nickel cathode containing less than 5 ppm sulfur was electrowon using a dimensionally stable inert anode contained in anode boxes which support a diaphragm cloth such that the anode compartment is separated from the cell catholyte. The nickel was electrowon from a mixed sulfate/chloride electrolyte containing 55 g/l Ni, 3-5 g/l Cl, 10 g/l Na and 6 g/l boric acid. The fresh feed solution contained 90 g/l Ni, 6 g/l Cl, 10 g/l Na and 6 g/l boric acid. DMHD was added to the feed solution to give a concentration of 150 ppm by weight. The fresh feed was added to the circulating cell electrolyte in order to maintain a constant volume of electrolyte within the cell, pH adjustment and circulation system. The circulating catholyte was sparged with air and its pH adjusted to 3.8 by the addition of 12.5% by weight Na₂CO₃ solution to the pH adjustment tank. The catholyte was circulated between the cell and the pH adjustment tank at a ratio of 10-20 times the feed rate. Anolyte and anode gases (chlorine and oxygen) were withdrawn from the anode boxes under vacuum. The temperature of the cell and the circulating electrolyte was maintained at 60° C. The applied current density was held constant at 220 amps/m² for 174 hrs of continuous deposition time. The current efficiency was calculated to be ˜98.6%. The resulting cathode had an average thickness of about 9.0 mm. As can be seen from FIG. 2, the cathode was smooth, compact, and bright, with a good edge-bead.

### EXAMPLE II

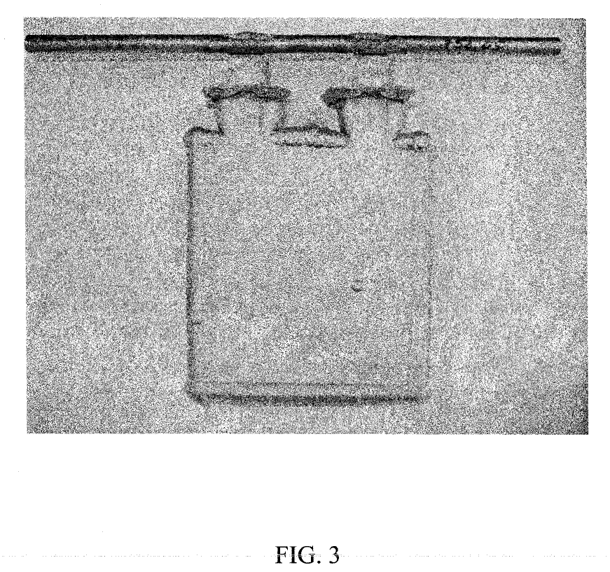

Electrolytic nickel cathode containing less than 5 ppm sulfur was electrowon in a bagged anode system. The nickel was electrowon from a mixed sulfate/chloride electrolyte containing 55 g/l Ni, 3-5 g/l Cl, 10 g/l Na and 6 g/l boric acid. The fresh feed solution contained 90 g/l Ni, 6 g/l Cl, 10 g/l Na and 6 g/l boric acid. DMHD was added to the feed solution to give a concentration of 100 ppm by weight. The fresh feed was added to the circulating cell electrolyte in order to maintain a constant volume of electrolyte within the cell, pH adjustment and circulation system. The circulating catholyte was sparged with air and its pH adjusted to 3.8±0.2 by the addition of 12.5% Na₂CO₃ solution to the pH adjustment tank. The catholyte was circulated between the cell and the pH adjustment tank at a rate of 10-20 times the feed rate. Anolyte and anode gases (chlorine and oxygen) were withdrawn from the anode boxes under vacuum. The temperature of the cell and the circulating electrolyte was maintained at 55° C. The applied current density was increased at several points during the deposition. A constant current of 220 amps/m² was passed for a total of 142 hrs. The current was raised to 240 amps/m² for 48 hrs and then to 270 amps/m² for the last 24 hours of deposition. The average current density was ˜230 amps/m². The current efficiency was calculated to be 98.6%. The resulting cathode had an average thickness of about 12.5 mm. As can be seen from FIG. 3, the cathode was smooth, compact, and bright, with a good edge-bead.

### EXAMPLE III

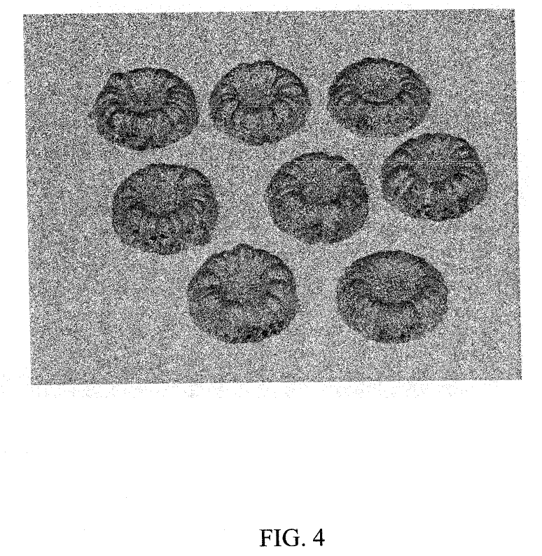

Electrolytic nickel ROUNDS™ forms containing less than 5 ppm sulfur were electrowon in a bagged anode system. The nickel was electrowon from a mixed sulfate/chloride electrolyte containing approximately 55 g/l Ni, 3-5 g/l Cl, 10 g/l Na and 6 g/l boric acid. The fresh feed solution contained approximately 88 g/l Ni, 6 g/l Cl, 10 g/l Na and 6 g/l boric acid. DMHD was added to the feed solution to give a concentration of 100 ppm by weight. The fresh feed was added to the circulating cell electrolyte in order to maintain a constant volume of electrolyte within the cell, pH adjustment and circulation system. The circulating catholyte was sparged with air and its pH adjusted to 3.9±0.2 by the addition of 12.5% Na₂CO₃ solution to the pH adjustment tank. The catholyte was circulated between the cell and the pH adjustment tank at a ration of 10-20 times the feed rate. Anolyte and anode gases (chlorine and oxygen) were withdrawn from the anode boxes under vacuum. The temperature of the cell and the circulating electrolyte was maintained at 60° C. The applied current density was increased at several points during the deposition. The current efficiency was calculated to be >98%. A sample of the resulting ROUNDS™ forms is shown in FIG. 4.

While in accordance with the provisions of the statute, there are illustrated and described herein specific embodiments of the invention, those skilled in the art will understand that changes may be made in the form of the invention covered by the claims and that certain features of the invention may sometimes be used to advantage without a corresponding use of the other features. For example, the concentrations, times, pH, current density, and electrolyte ingredients may be varied by those skilled in the art in accordance with conventional wisdom.

What is claimed is:

1. An acidic aqueous electrolyte solution for production of a nickel cathode comprising nickel ions, and 2,5-dimethyl-3-hexyne-2,5-diol.

2. An acidic aqueous electrolyte solution for production of a nickel cathode according to claim 1 comprising about 0 to about 30 g/l chloride, about 1-30 g/l sodium, about 0 to about 20 g/l boric acid and about 5 ppm to about 300 ppm 2,5-dimethyl-3-hexyne-2,5-diol.

3. An acidic aqueous electrolyte solution for production of a nickel cathode according to claim 2 comprising about 48 to about 100 g/l nickel, about 3 to about 8 g/l chloride, about 8 to about 12 g/l sodium, about 4 to about 8 g/l boric acid and about 80 to about 175 ppm 2,5-dimethyl-3-hexyne-2,5-diol.

4. An acidic aqueous electrolyte solution for production of a nickel cathode according to claim 3 comprising about 90 g/l nickel, about 6 g/l chloride, about 10 g/l sodium, about 6 g/l boric acid and about 100 to about 150 ppm 2,5-dimethyl-3-hexyne-2,5-diol.

5. An acidic aqueous electrolyte solution for production of a nickel cathode according to claim 1 further comprising an additive selected from the group consisting of surfactants, brighteners and emulsifiers.

6. A cell for electrowinning or electrorefining nickel comprising an acidic aqueous electrolyte solution for production of a nickel cathode according to claim 1.

7. A process for electrowinning or electrorefining a nickel cathode comprising: providing an acidic aqueous electrolyte solution including nickel ions, and 2,5-dimethyl-3-hexyne-2,5-diol; and electrolytically depositing nickel to form a nickel cathode.

8. A process for electrowinning or electrorefining a nickel cathode according to claim 7 wherein the acidic aqueous electrolyte solution includes about 0 to about 30 g/l chloride, about 1-30 g/l sodium, about 0 to about 20 g/l boric acid and about 5 to about 300 ppm 2,5-dimethyl-3-hexyne-2,5-diol.

9. A process for electrowinning or electrorefining a nickel cathode according to claim 8 wherein the acidic aqueous electrolyte solution includes about 48 to about 100 g/l nickel, about 3 to about 8 g/l chloride, about 8 to about 12 g/l sodium, about 4 to about 8 g/l boric acid and about 80 to about 175 ppm 2,5-dimethyl-3-hexyne-2,5-diol.

10. A process for electrowinning or electrorefining a nickel cathode according to claim 9 wherein the acidic aqueous electrolyte solution includes about 90 g/l nickel, about 6 g/l chloride, about 10 g/l sodium, about 6 g/l boric acid and about 100 to about 150 ppm 2,5-dimethyl-3-hexyne-2,5-diol.

11. A process for electrowinning or electrorefining a nickel cathode according to claim 7 wherein the process is carried out at a temperature between about 30° C. and 90° C.

12. A process for electrowinning or electrorefining a nickel cathode according to claim 11 wherein the process is carried out at about 60° C.

13. A process for electrowinning or electrorefining a nickel cathode according to claim 7 wherein the process is carried out at a current density between about 200 A/m² and about 800 A/m².

14. A process for electrowinning or electrorefining a nickel cathode according to claim 13 wherein the current density is about 220 A/m² and about 270 A/m².

15. A process for electrowinning or electrorefining a nickel cathode according to claim 7 wherein the pH of the acidic aqueous electrolyte solution is from about 3.5 to about 4.5.

16. A process for electrowinning or electrorefining a nickel cathode according to claim 7 wherein the cathode is substantially sulfur-free.

17. A process for electrowinning or electrorefining a nickel cathode according to claim 7 wherein the nickel cathode is at least about 1 mm thick.

18. A process for electrowinning or electrorefining a nickel cathode according to claim 7 wherein the nickel cathode is deposited from catholyte prepared by leaching of nickel concentrates, nickel mattes or a combination thereof.

19. A process for electrowinning or electrorefining a nickel cathode according to claim 7 wherein the nickel cathode is deposited using a dissolving matte anode.

20. A process for electrowinning or electrorefining a nickel cathode according to claim 7 wherein the acidic aqueous solution includes an additive selected from the group consisting of surfactants, brighteners and emulsifiers.
